(19) United States
(12) Patent Application Publication
(10) Pub. No.: US 2005/0179534 A1
(43) Pub. Date: Aug. 18, 2005

(54) Rod device to signal more vehicles in traffic

(76) Inventor: Roger Boudreaux, Falls Church, VA (US)

Correspondence Address: ROGER BOUDREAUX, 6139 Leesburg # 503, Fall Church, VA, 22041, US

(21) Appl. No.: 11/049,040

(22) Filed: Feb. 3, 2005

Related U.S. Application Data
(60) Provisional application No. 60/544,635, filed on Feb. 17, 2004.

(51) Int. Cl. B60Q 1/44

(52) U.S. Cl. 340/479; 340/464

(57) ABSTRACT

A device for signaling or warning to on coming traffic that you the driver is making a stop. With BOAR3 it allows more vehicles to see ahead a prepare to stop.

This application claims the benefit of U.S. Provisional Application No. 60/544,635, filed Feb. 17, 2004, which is herein incorporated by Reference in its entirety.

### BACKGROUND

1. Field of the Invention

The present invention relates generally to providing a warning device to vehicles behind other vehicles. More particularly, BOAR3 prevents other vehicles from making sudden stops because of the long rod of BOAR3 attached to the vehicles, therefore making the light more visable.

2. Background of the Invention

BOAR3 is a brake-light on a rod which signal to other drivers that they are stopping, which prevent no surprises for several vehicles back.

### BRIEF SUMMARY OF THE INVENTION

The present invention represent a valuable tool to warn more vehicles to prepare to stop. BOAR3 is valuable in possibly saving many lives that's loss in automobiles accidents each year.

Finally, BOAR3 can alert much more cars and trucks then the current system that exist.

### BRIEF DESCRIPTION OF THE DRAWINGS

FIG. 1 is a schematic overview at the BOAR3 in action.

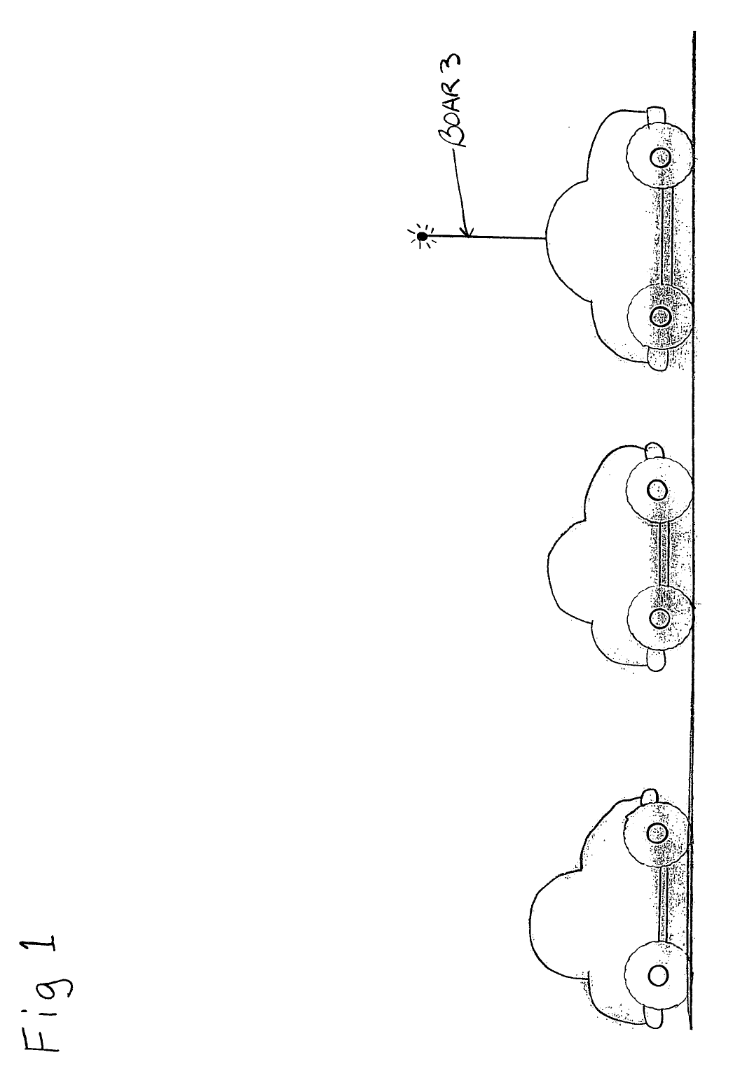

FIG. 2 is a schematic representation of the BOAR3.

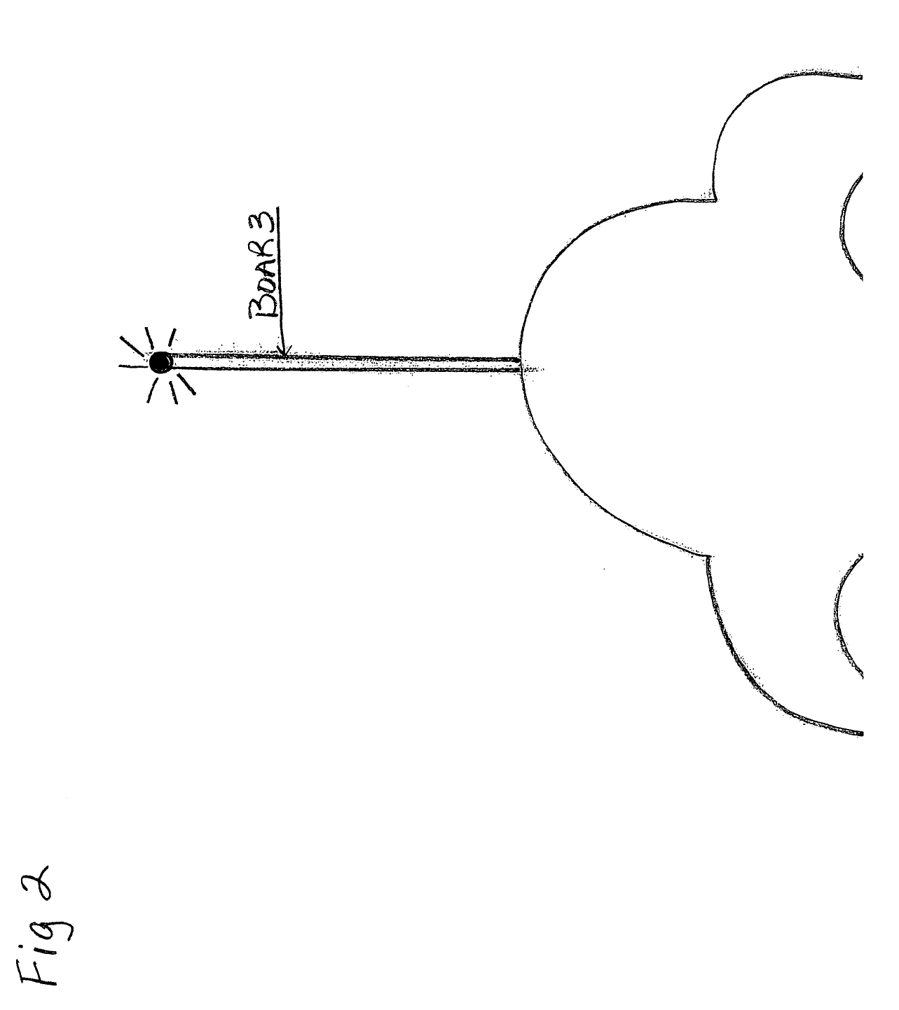

### DETAILED DESCRIPTION OF THE INVENTION

BOAR3 represents a new signal. The rod can be attached to any vehicle mounted on the antenna or positioned anywhere on top of the vehicles.

Similar to the existing brake light, BOAR3 system would warn more vehicles to stop. BOAR3 added value to this system is that more vehicles would see and brake sooner then later. Therefore, preventing more accidents.

1. A brake light device that allows more than one vehicles to stop their car more sooner.
